(19) United States
(12) Patent Application Publication
(10) Pub. No.: US 2020/0402141 A1
(43) Pub. Date: Dec. 24, 2020

(54) METHODS FOR GENERATING A REAL TIME CUSTOMER CURATED STOREFRONT ELECTRONIC INTERFACE AND DEVICES THEREOF

(71) Applicant: Garsa Holding S.A. de C.V., San Pedro Garza Grarcia (MX)

(72) Inventors: Fernando García Sada, San Pedro Garza García (MX); Sergio de Jesús Elizondo Muñoz, San Pedro Garza García (MX); John Stephen Romney, Cedar Park, TX (US); Mauricio Varela Treviño, San Pedro Garza García (MX); Javier Abdeel Gomez Trejo, Guadalupe (MX)

(21) Appl. No.: 16/450,403

(22) Filed: Jun. 24, 2019

(51) Int. Cl. G06Q 30/06; G06F 9/451; G06Q 30/02

(52) U.S. Cl. CPC G06Q 30/0641; G06Q 30/0255; G06F 9/451

(57) ABSTRACT

This technology establishing, by the computing device, one or more communication links with one or more vendor computing systems based on selected category-and-subcategory data for selected brand data in a customized shopping preference data set associated with a digital identifier. The customized shopping preference data set is solely based on consumer input data associated with the digital identifier and comprises the selected category-and-subcategory data for selected brand data, consumer characteristic data, and one or more types of notifications related to the selected category-and-subcategory data. An arrangement of a layout of a customer curated storefront electronic interface is generated in real time, by the computing device, based on a real time correlation of any of a plurality of items at the one or more linked vendor systems matching the consumer characteristic data, the selected category-and-subcategory data for the selected brand data, at least one attribute related to the selected categories and subcategories for the selected brand data, and interface layout structure data. The real time generated layout of the customer curated storefront electronic interface is provided, by the computing device, to a consumer device associated with the digital identifier.

### FIELD

This technology relates to methods for generating a real time customer curated storefront electronic interface and devices thereof.

### BACKGROUND

Consumers today are facing an immense and growing array of shopping choices for on-line items that they may want or need. While expanding options for shopping initially may be welcome, consumers are becoming increasingly overwhelmed with respect to information about possible options. This is leading to an increase in consumer frustration and uncertainty in making shopping decisions and occasionally resulting in anger or regret when selected items fall short of expectations resulting in a waste of money. Further, with this drastic increase in options, the advice of friends or family often is no longer available leading to further poor shopping decisions.

Similarly, vendors are facing increase pressure to provide consumers with new and different items. Unfortunately, vendors are often unsure of what overall consumer demand may be for different items and have limited visibility on targeted advertising for these items, in particular new items being introduced.

To try and address these issues, a variety of on-line shopping software management tools have been developed. Unfortunately, these tools have failed to enhance and provide a curated shopping experience that is effectively linked to vendors or other third parties.

### SUMMARY

A method includes establishing, by a computing device, one or more communication links with one or more vendor computing systems based on selected category-and-subcategory data for selected brand data in a customized shopping preference data set associated with a digital identifier. The customized shopping preference data set is solely based on consumer input data associated with the digital identifier and comprises the selected category-and-subcategory data for the selected brand data, consumer characteristic data, and one or more types of notifications related to the selected category-and-subcategory data. An arrangement of a layout of a customer curated storefront electronic interface is generated in real time, by the computing device, based on a real time correlation of any of a plurality of items at the one or more linked vendor systems matching the consumer characteristic data, the selected category-and-subcategory data for the selected brand data, at least one attribute related to the selected categories and subcategories for the selected brand data, and interface layout structure data. The real time generated layout of the customer curated storefront electronic interface is provided, by the computing device, to a consumer device associated with the digital identifier.

An electronic interface management computer apparatus includes a memory coupled to a processor which is configured to be capable of executing programmed instructions comprising and stored in the memory to establish one or more communication links with one or more vendor computing systems based on selected category-and-subcategory data for selected brand data in a customized shopping preference data set associated with a digital identifier. The customized shopping preference data set is solely based on consumer input data associated with the digital identifier and comprises the selected category-and-subcategory data for the selected brand data, consumer characteristic data, and one or more types of notifications related to the selected category-and-subcategory data. An arrangement of a layout of a customer curated storefront electronic interface is generated in real time based on a real time correlation of any of a plurality of items at the one or more linked vendor systems matching the consumer characteristic data, the selected category-and-subcategory data for the selected brand data, at least one attribute related to the selected categories and subcategories for the selected brand data, and interface layout structure data. The real time generated layout of the customer curated storefront electronic interface is provided to a consumer device associated with the digital identifier.

A non-transitory computer readable medium having stored thereon instructions comprising executable code which when executed by one or more processors, causes the one or more processors to establish one or more communication links with one or more vendor computing systems based on selected category-and-subcategory data for selected brand data in a customized shopping preference data set associated with a digital identifier. The customized shopping preference data set is solely based on consumer input data associated with the digital identifier and comprises the selected category-and-subcategory data for the selected brand data, consumer characteristic data, and one or more types of notifications related to the selected category-and-subcategory data. An arrangement of a layout of a customer curated storefront electronic interface is generated in real time based on a real time correlation of any of a plurality of items at the one or more linked vendor systems matching the consumer characteristic data, the selected category-and-subcategory data for the selected brand data, at least one attribute related to the selected categories and subcategories for the selected brand data, and interface layout structure data. The real time generated layout of the customer curated storefront electronic interface is provided to a consumer device associated with the digital identifier.

This technology provides a number of advantages including providing methods, non-transitory computer readable media, apparatuses that provide a real time real time generation of a layout of an customer curated storefront electronic interface with customized integration with one or more vendor server devices or other third party computing devices. With this technology, consumers are quickly and efficiently provided shopping data in a real time generated layout of the customer curated storefront electronic interface. This real time generated electronic interface may uniquely provide a customized interactive display of real time wants or needs based on selected category-and-subcategory data for the selected brand data and at least one attribute related to the selected category-and-subcategory data for the selected brand data that makes online shopping more effective and efficient with less stress. In particular, the layout of the customer curated storefront electronic interface generated in real time helps to streamline the decision-making process by consumers and increases resulting electronic online shopping purchases. Even further, with this technology vendor systems are in real time linked and are continuously provided with updated intelligence data saving vendors substantial time and money with respect to market research, managing inventory, and directing targeted advertising.

### BRIEF DESCRIPTION OF THE DRAWINGS

FIG. 1 is a diagram of an exemplary environment with an example of an electronic interface management computing device;

FIG. 2 is a diagram of an example of the electronic interface management computing device shown in FIG. 1;

FIG. 3 is a flowchart of an example of a method for managing coupling and interaction of one or more of the vendor server devices with one or more digital identifiers;

FIG. 4 is a flowchart of an example of a method for generating a real time real time layout of one or more customer curated storefront electronic interfaces which optionally may integrate targeted electronic advertising;

FIG. 5 is a flowchart of an example of a method for making a purchase of an item presented with a customer curated storefront electronic interface;

FIG. 6 is a screenshot of an example of a brand search page;

FIG. 7 is a screenshot of an example of a landing search page of a customer curated storefront electronic interface to select one or more categories and subcategories;

FIG. 8 are screenshots of examples of notification management pages to set up or adjust one or more notifications; and

FIG. 9 is a screenshot of an example of an initial page for a customer curated storefront electronic interface.

### DETAILED DESCRIPTION

An exemplary environment 10 with an electronic interface management computing device 12 that is coupled to a plurality of vendor server devices 14(1)-14(n) and a plurality of consumer devices 16(1)-16(n) via communication network(s) 18, although the electronic interface management computing device 12, vendor server devices 14(1)-14(n), and/or consumer devices 16(1)-16(n) may be coupled together via other topologies. Additionally, this environment may include other network devices, such as one or more routers and/or switches, for example, which are well known in the art and thus will not be described herein. This technology provides a number of advantages including methods, non-transitory computer readable media, apparatuses that manage providing real time generation of a customer curated storefront electronic interface based on solely customer curated wants-and-needs data with customized integration with one or more vendor server devices or other third party computing devices.

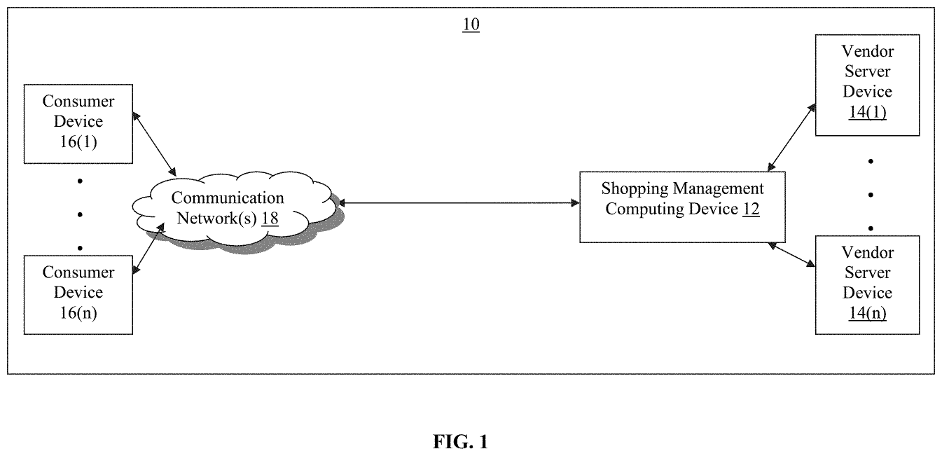

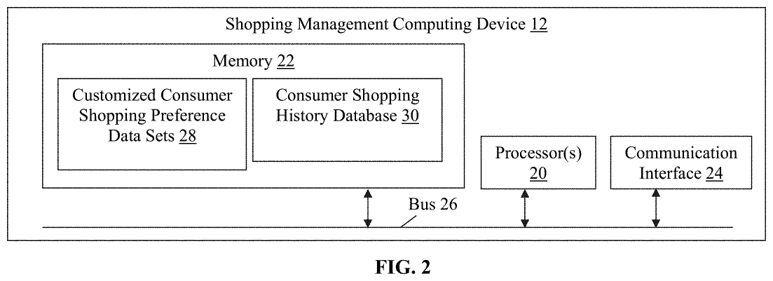

Referring to FIGS. 1-2, the electronic interface management computing device 12 may perform any number of functions including by way of example managing real time generation of a real time adjusted layout of customer curated storefront electronic interface based on solely customer curated wants-and-needs data. The electronic interface management computing device 12 may include a processor(s) 20, a memory 22, and/or a communication interface 24, which are coupled together by a bus or other communication link 26, although the electronic interface management computing device 12 can include other types and/or numbers of elements in other configurations.

The processor(s) 20 of the electronic interface management computing device 12 may execute programmed instructions stored in the memory of the electronic interface management computing device 12 for the any number of the functions identified above. The processor(s) 20 of the electronic interface management computing device 12 may include one or more CPUs or general purpose processors with one or more processing cores, for example, although other types of processor(s) also can be used.

The memory 22 of the electronic interface management computing device 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 20, can be used for the memory 22.

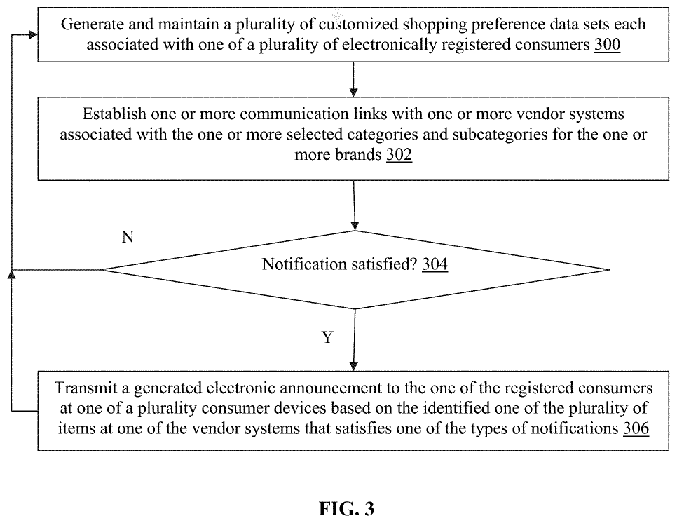

Accordingly, the memory 22 of the electronic interface management computing device 12 can store one or more applications that can include computer executable instructions that, when executed by the electronic interface management computing device 12, cause the electronic interface management computing device 12 to perform actions, such as to transmit, receive, or otherwise process messages, for example, and to perform other actions described and illustrated by way of the examples below with reference to FIGS. 3-9. The application(s) can be implemented as modules or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the electronic interface management computing device 12 itself, may be located in virtual server(s) running in a cloud-based computing environment rather than being tied to one or more specific physical network computing devices. Also, the application(s) may be running in one or more virtual machines (VMs) executing on the electronic interface management computing device 12. Additionally, in one or more embodiments of this technology, virtual machine(s) running on the electronic interface management computing device 12 may be managed or supervised by a hypervisor.

In this particular example, the memory 22 of the electronic interface management computing device 12 includes a customized consumer shopping preference database 28 and a consumer shopping history database 30, although the memory can include other policies, modules, databases, or applications, for example. The customized consumer shopping preference database 28 for each of the register consumers may include customized shopping preference data sets comprising customer characteristics data, selected category-and-subcategory data for selected brand data, and one or more types of notifications related to the selected category-and-subcategory data which are all input and managed at least by the consumers, although each data set may include other types and/or amounts of information. The consumer shopping history database 30 may include a purchasing history for the selected category-and-subcategory data for the selected brand data, although other types and/or amounts of purchase history data may be stored.

The communication interface 24 of the electronic interface management computing device 12 operatively couples and communicates between the electronic interface management computing device 12, the vendor server devices 14(1)-14(n), and/or the consumer devices 16(1)-16(n), which are all coupled together by the communication network(s) 18, although other types and/or numbers of communication networks or systems with other types and/or numbers of connections and/or configurations to other devices and/or elements can also be used.

By way of example only, the communication network(s) 18 can include local area network(s) (LAN(s)) or wide area network(s) (WAN(s)), and can use TCP/IP over Ethernet and industry-standard protocols, although other types and/or numbers of protocols and/or communication networks can be used. The communication network(s) 18 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication network(s) 18 can also include direct connection(s) (e.g., for when a device illustrated in FIG. 1, such as the electronic interface management computing device 12, one or more of the vendor server devices 14(1)-14(n), or one or more of the consumer devices 16(1)-16(n) operate as virtual instances on the same physical machine).

While the electronic interface management computing device 12 is illustrated in this example as including a single device, the electronic interface management computing device 12 in other examples can include a plurality of devices or blades each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the electronic interface management computing device 12.

Additionally, one or more of the devices that together comprise the electronic interface management computing device 12 in other examples can be standalone devices or integrated with one or more other devices or apparatuses, such as one of the vendor server devices 14(1)-14(n), for example. Moreover, one or more of the devices of the electronic interface management computing device 12 in these examples can be in a same or a different communication network including one or more public, private, or cloud networks, for example.

Each of the vendor server devices 14(1)-14(n) in this example includes one or more processors, a memory, and a communication interface, which are coupled together by a bus or other communication link, although other numbers and/or types of network devices could be used. The vendor server devices 14(1)-14(n) in this example process requests received from the electronic interface management computing device 12 and/or consumer devices 16(1)-16(n) via the communication network(s) 18. Various applications may be operating on the vendor server devices 14(1)-14(n) and transmitting data (e.g. web pages) to the consumer devices 16(1)-16(n) via the electronic interface management computing device 12 in response to requests from the consumer devices 16(1)-16(n). The vendor server devices 14(1)-14(n) may be hardware or software or may represent a system with multiple servers in a pool, which may include internal or external networks.

Although the vendor server devices 14(1)-14(n) are illustrated as single devices, one or more actions of each of the vendor server devices 14(1)-14(n) may be distributed across one or more distinct network computing devices that together comprise one or more of the vendor server devices 14(1)-14(n). Moreover, the vendor server devices 14(1)-14(n) are not limited to a particular configuration. Thus, the vendor server devices 14(1)-14(n) may contain a plurality of network computing devices that operate using a master/slave approach, whereby one of the network computing devices of the vendor server devices 14(1)-14(n) operate to manage and/or otherwise coordinate operations of the other network computing devices. The vendor server devices 14(1)-14(n) may operate as a plurality of network computing devices within a cluster architecture, a peer-to peer architecture, virtual machines, or within a cloud architecture, for example.

Thus, the technology disclosed herein is not to be construed as being limited to a single environment and other configurations and architectures are also envisaged. For example, one or more of the vendor server devices 14(1)-14(n) can operate within the electronic interface management computing device 12 itself rather than as a stand-alone store server device communicating with the electronic interface management computing device 12 via the communication network(s).

The consumer devices 16(1)-16(n) in this example include any type of computing device, such as mobile computing devices, desktop computing devices, laptop computing devices, tablet computing devices, virtual machines (including cloud-based computers), or the like. Each of the consumer devices 16(1)-16(n) in this example includes a processor, a memory, and a communication interface, which are coupled together by a bus or other communication link, although other numbers and/or types of network devices could be used.

The consumer devices 16(1)-16(n) may run interface applications, such as standard Web browsers or standalone client applications, which may provide an interface to make requests for, and receive content from the electronic interface management computing device 12 and/or one or more of the vendor server devices 14(1)-14(n) via the communication network(s). The consumer devices 16(1)-16(n) may further include a display device, such as a display screen or touchscreen, and/or an input device, such as a keyboard for example.

Although the exemplary electronic interface management computing device 12, vendor server devices 14(1)-14(n), consumer devices 16(1)-16(n), and communication network(s) 18 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the electronic interface management computing device 12, vendor server devices 14(1)-14(n), or consumer devices 16(1)-16(n), or for example, may be configured to operate as virtual instances on the same physical machine. In other words, one or more of the electronic interface management computing device 12, vendor server devices 14(1)-14(n), or consumer devices 16(1)-16(n), may operate on the same physical device rather than as separate devices communicating through communication network(s). Additionally, there may be more or fewer electronic interface management computing device 12, vendor server devices 14(1)-14(n), or consumer devices 16(1)-16(n) than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

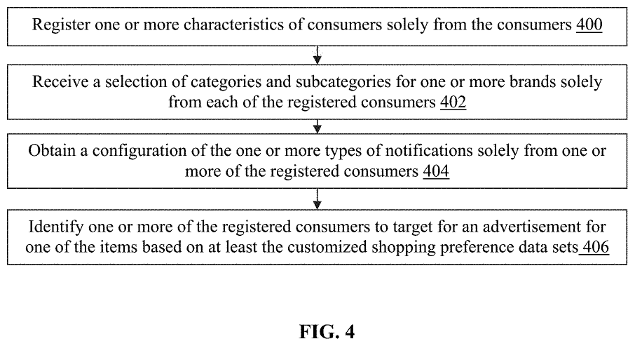

An example of a method for managing coupling and interaction of one or more vendor systems at one or more of the vendor server devices 14(1)-14(n) with one or more digital identifiers associated with one or more consumer devices 16(1)-16(n) will now be described with reference to FIGS. 1-3. Referring more specifically to FIG. 3, in this example in step 300 the electronic interface management computing device 12 maintains a plurality of real time and customized shopping preference data sets generated and managed solely by a plurality of consumers associated with digital identifiers for corresponding consumer devices 16(1)-16(n). An example of a method for generating a real time real time layout of one or more customer curated storefront electronic interfaces which optionally may integrate targeted electronic advertising will be described later herein with reference to FIG. 4. In this example, each of the customized shopping preference data sets comprises customer characteristics data, selected category-and-subcategory data for selected brand data, and one or more types of notifications related to selected category-and-subcategory data and the selected brands which are input and managed at least by the consumers at the one or more consumer devices 16(1)-16(n), although each of these data sets may comprise other types and/or amounts of other information.

In step 302, the electronic interface management computing device 12 may establish one or more communication links with one or more vendor server devices 14(1)-14(n) based on the selected category-and-subcategory data for the selected brand data in each of the customized shopping preference data sets. A variety of manners for establishing these links may be utilized relating to the selected category-and-subcategory data for the selected brand data in each of the customized shopping preference data sets. For example, the electronic interface management computing device 12 may correlate based on a stored table the particular ones of the vendor server devices 14(1)-14(n) associated with the selected category-and-subcategory data for the selected brand data and then may periodically poll those vendor server devices 14(1)-14(n) for any updates regarding the corresponding stored notifications, although other manners for establishing links could be used.

In step 304, the electronic interface management computing device 12 determines when one of the stored notifications for the selected category-and-subcategory data for the selected brand data and in one of the customized shopping preference data sets along with at least one other attribute related to the selected category-and-subcategory data for the selected brand data has been satisfied by one or more items at one or more of the vendor server devices 14(1)-14(n). By way of example only, the additional attribute may be the seasonal data, such as seasonal data identifying one of the spring, summer, fall, or winter season, although other types and/or numbers of other attributes may be considered and utilized, such as holiday data relating to one or more dates of particular holidays, celebrations or other event data by way of example only. Accordingly, in this example satisfaction of one of the stored notifications may require that a new item matches at least part of the consumer characteristics data, one of the selected category-and-subcategory data for one the selected brand data and also satisfies the one or more additional attributes, such as the spring, summer, fall, or winter season associated with the new item, i.e. a new bathing suit of a particular color, style and size by a particular brand would also be associated with the attribute of the summer season so the next upcoming season based on the current calendar would need to be the summer season.

If in step 304 the electronic interface management computing device 12 determines that none of the stored notifications have currently been satisfied, then the No branch is taken back to step 300 where the electronic interface management computing device 12 continues to generate and maintain the plurality of customized shopping preference data sets as described earlier. If in step 304 the electronic interface management computing device 12 determines that one of the stored notifications have currently been satisfied, then the Yes branch is taken to step 306.

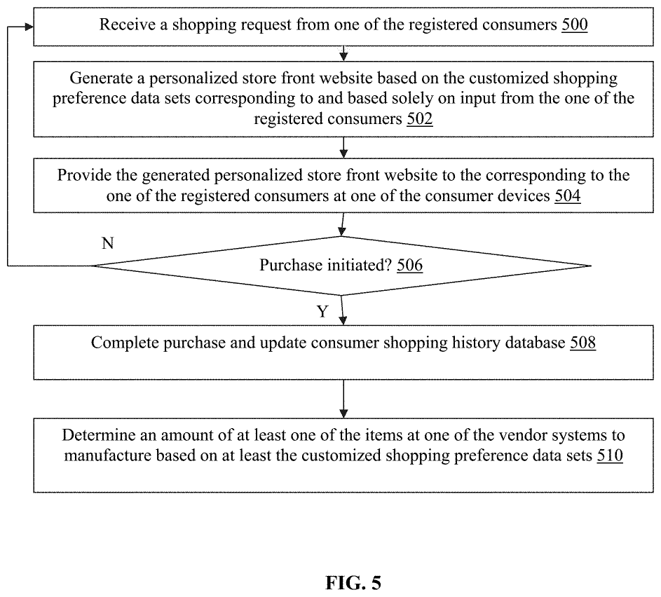

In step 306, the electronic interface management computing device 12 generates an electronic announcement to the one of the consumer devices 16(1)-16(n) with the digital identifier associated with the one of the notifications about the item available at one of the vendor server devices 14(1)-14(n), although other options for presenting the item may be used, such as generating a new real time layout of the customer curated storefront electronic interface arranged in real time to for example provide an interactive panel with the item. By way of example, an example of a method for making a purchase of this item presented based on one of the customized shopping preference data sets is illustrated in FIG. 5 described in greater detail below. Next, this method may proceed back to step 300 where the electronic interface management computing device 12 continues to generate and maintain the plurality of customized shopping preference data sets as described earlier.

Through part or all of this exemplary process, the consumer at the one of the consumer devices 16(1)-16(n) may be placed in direct communication, such as by text, email, or any other electronic communication system, with the one of the vendor server devices 14(1)-14(n), which for example may be the manufacturer associated with the item. As a result, with this direct link and sharing of purchasing intelligence data in real time, the consumer at the one of the consumer devices 16(1)-16(n) will receive enhanced communications and service along with better pricing than previously possible and the one of the vendor server devices 14(1)-14(n) will have reduced uncertainty and improved accuracy in sales forecasting of items, thus improving and optimizing the allocation of manufacturing capacity and streamlining just-in-time inventory in the supply chain. This direct link and real time purchasing intelligence data sharing also reduces marketing costs, logistics costs, labor costs, and time to market (manufacturing lead time) and also simplifies the supply chain, reduces lost sales, and reduces backorders.

Referring to FIGS. 1-2, 4, and 6-8 an example of a method for generating a real time real time arrangement of a layout of one or more customer curated storefront electronic interfaces which optionally may integrate targeted electronic advertising and/or provide one or more types of electronic communication directly between the customer and the vendor, manufacturer or other third party is illustrated. In step 400, the electronic interface management computing device 12 may register or otherwise obtain consumer characteristics data to be associated with a digital identifier at one or more of the consumer devices 16(1)-16(n) during an initial registration process and may update on an ongoing basis. In some examples of this technology, consumers associated to the digital identifiers at one or more of the consumer devices 16(1)-16(n) may remain anonymous. The consumer characteristics data may be obtained through monitoring, inquiries, input from at least one or more of the consumers at one or more of the consumer devices 16(1)-16(n) each having a digital identifier, and/or anonymously by analysis or other mechanisms so that a curated shopping preference data set is set to the particular consumer desires. By way of example only, the consumer characteristic data may comprise gender, age, sizes, style preferences, and/or color preferences, such as a consumer's size for shoes, pants, shirts, preferred colors, etc, although other types and/or numbers of other characteristics may be stored and associated with one or more of the customized shopping preference data sets being generated.

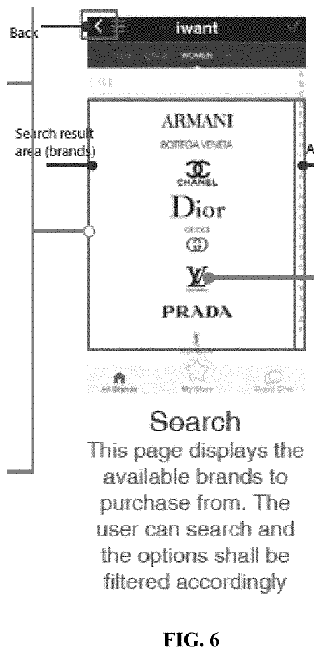

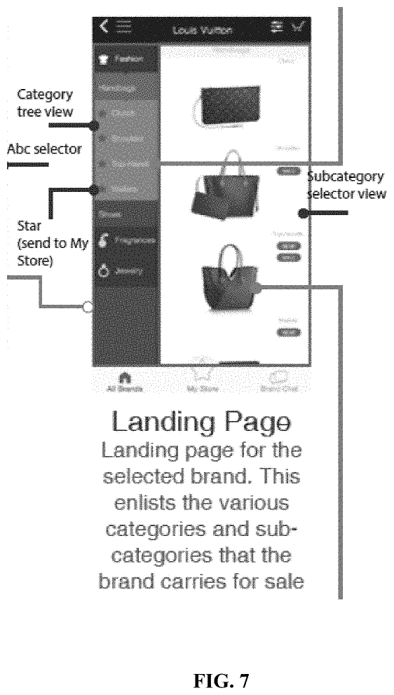

In step 402, the electronic interface management computing device 12 may provide a brand search page to one of the consumer devices 16(1)-16(n) to receive a selection data for one or more available brands to generate selected brand data for use in generating the layout of the electronic interface, although other manners for obtaining selected brand data may be used. In this example, the selection of brands is driven by the consumer at one of the consumer devices 16(1)-16(n) without any outside input. By way of example only, a screenshot of an example of a brand search page is illustrated in FIG. 6. Next, based on the selected brand data, the electronic interface management computing device 12 may in real time generate a layout of a customer curated storefront electronic interfaces that is provided to the consumer at one of the consumer devices 16(1)-16(n). By way of example only, a screenshot of an example of a landing search page to select one or more categories and subcategories for the category-and-subcategory data associated with each of the digital identifiers for use in generating the layout of the electronic interface is illustrated in FIG. 7. At any time, the consumer at one of the consumer devices 16(1)-16(n) may in real time revise these selections of category-and-subcategory data and/or brand data with the electronic interface management computing device 12 by, for example, adding or removing selected brand data and/or adding or removing selected category-and-subcategory data. The electronic interface management computing device 12 stores these selections and/or adjustments in a corresponding one of the customized shopping preference data sets, although this could be stored in other location and/or manners.

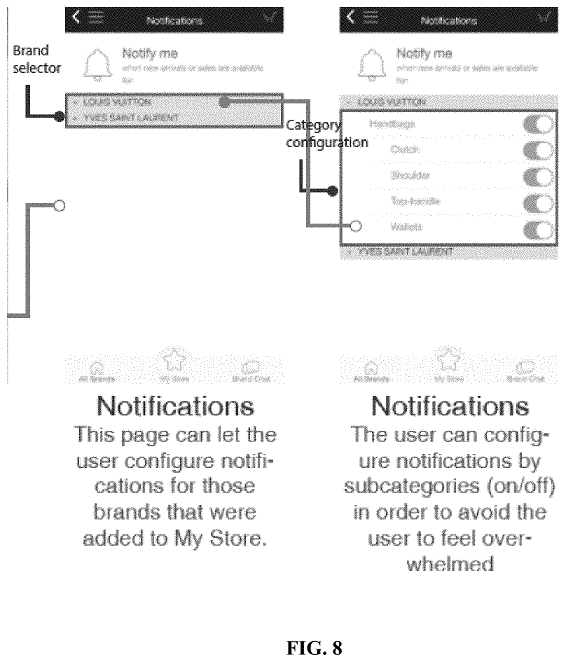

In step 404, the electronic interface management computing device 12 may provide one or more notification management pages to the consumer at one of the consumer devices 16(1)-16(n) to receive input for one or more types of notifications associated with the selected category-and-subcategory data for the the selected brand data for use in generating the layout of the electronic interface. Again the input for one or more types of notifications associated with the consumer characteristics data and the selected category-and-subcategory data for the selected brand data is obtained solely from the consumer via one of the consumer devices 16(1)-16(n) providing the consumer ultimate and sole control over any notifications as well as the customized shopping preference data set. By way of example only, screenshots of notification management pages are illustrated in FIG. 8. By way of example, one notification may be a new release notification for a new one of the plurality of items offered by one of the vendor server devices 14(1)-14(n) in the selected category-and-subcategory data for the selected brand data. By way of another example, another one of the notification may be a sale notification for one of the plurality of items offered by one of the vendor server devices 14(1)-14(n) in the selected category-and-subcategory data for the selected brand data having a sale. Other types and/or numbers of other notifications may be established. Additionally, each of these notifications may have other types and/or numbers of attributes that need to be satisfied, such as the one illustrated and described earlier in the example in step 304.

In step 406, the electronic interface management computing device 12 also may optionally identify one or more of the consumers at one or more of the consumer devices 16(1)-16(n) or one or more digital identifiers associated with the one or more consumer devices 16(1)-16(n) to target for electronic advertisement for one of the items based on at least the customized shopping preference data sets for use in generating the layout of the electronic interface which again are set and managed solely by the consumers. By way of example, the electronic interface management computing device 12 may be able to link with one or more of the vendor server devices 14(1)-14(n) and obtain particular advertising data related to the selected category-and-subcategory data for the selected brand data corresponding with the consumer characteristics data and then direct the obtained advertising data to the corresponding one or more of the consumer devices 16(1)-16(n). Further, the electronic interface management computing device 12 may request and obtain for one or more digital identifiers associated with the one or more consumer devices 16(1)-16(n) other data which can be used to generate the dynamic layout of the electronic interface, such as past stored purchasing history data or browsing history data to identify items or other products to display by way of example. Additionally, the electronic interface management computing device 12 may request and receive stored interface layout structure data for how to structure the particular arrangement of different portions of the layout of the electronic interface from one of the one or more of the vendor server devices 14(1)-14(n) and/or from other sources, such as manufacturers by way of example. In addition to identifying particular locations for portions of the electronic interface, the interface layout structure data may further comprise for example particular font sizes and/or boundaries of different portions or regions of the interface as well as other types of formatting including additional links to other web sites.

Referring to FIGS. 1-2, 5, and 9, an example of a method for making a purchase of an item based on one of the customized shopping preference data sets utilizing one of the real time generated customer curated storefront electronic interfaces is illustrated. In step 500, the electronic interface management computing device 12 may receive a shopping inquiry request from one of one of the consumer devices 16(1)-16(n).

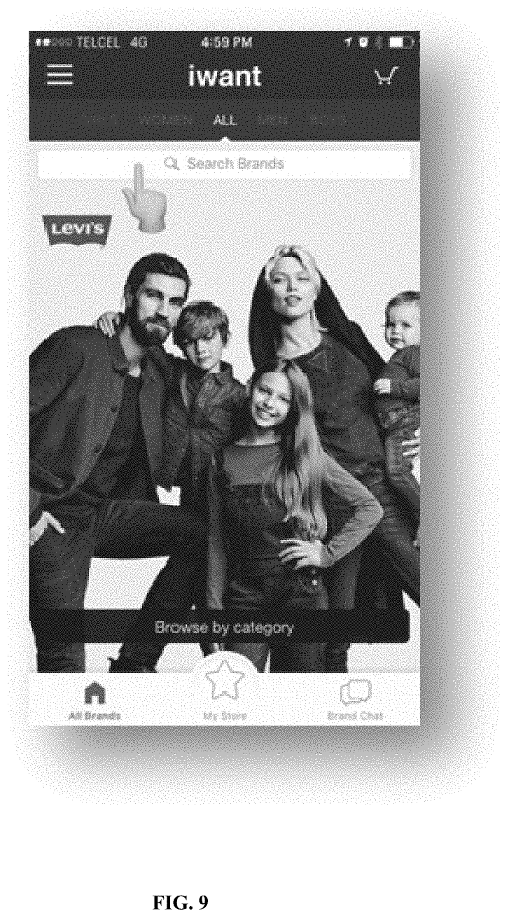

In step 502, the electronic interface management computing device 12 may generate in real time a real time layout of a customer curated storefront electronic interface based on a correlation of one of a plurality of items at or otherwise associated with the one or more linked vendor server devices 14(1)-14(n) matching the consumer characteristics data, the selected category-and-subcategory data for the selected brand data, and at least one attribute related to the selected category-and-subcategory data for the selected brand data in one of the customized shopping preference data sets, although the curated storefront electronic interface could be generated in other manners. By way of example only, the curated storefront electronic interface may be a website, webpage, mobile application, table application, desktop application, touchscreen interface, graphical user interface or any other electronic interface or platform. By way of example only, a screenshot of initial page for a real time generated customer curated storefront electronic interface is illustrated in FIG. 9. Additionally, throughout this exemplary process the provided electronic interface may provide direct electronic communication between the one of the consumer devices 16(1)-16(n) and for example one or more of the vendor server devices 14(1)-14(n) or manufacturers of the items or other products on the electronic interface.

In step 504, the electronic interface management computing device 12 may provide the real time generated curated storefront electronic interface to the corresponding one of the consumer devices 16(1)-16(n).

In step 506, the electronic interface management computing device 12 determines when a purchase has been initiated via the real time generated customer curated storefront electronic interface by one of the consumer devices 16(1)-16(n). If in step 506, the electronic interface management computing device 12 determines a purchase has not been initiated, then the No branch may be taken back to step 500 as described earlier in this example. If in step 506, the electronic interface management computing device 12 determines a purchase has been initiated, then the Yes branch may be taken to step 508.

In step 508, the electronic interface management computing device 12 may complete the purchase by the one of the consumer devices 16(1)-16(n) and update the consumer shopping history database 30 with the purchase information and/or other activity by the digital identifier associated with the one of the consumer devices 16(1)-16(n).

In step 510, the electronic interface management computing device 12 may determine an amount of at least one of the items offered by one of the vendor systems at one of the vendor server devices 14(1)-14(n) to manufacture based on at least the generated customized shopping preference data sets and/or purchase history data which can then be provided to one or more of the vendor server devices 14(1)-14(n), although other and/or additional information may also be utilized to determine an amount of an item to manufacture, such as stored data in the consumer shopping history database 30.

Accordingly, as illustrated and described by way of the examples herein the claimed technology provides effective real time real time generation of a layout of a customer curated storefront electronic interface. With this technology, consumers are quickly and efficiently provided shopping data in a real time generated layout of the customer curated storefront electronic interface. This real time generated electronic interface may uniquely provide a customized interactive display of real time wants or needs based on selected category-and-subcategory data for the selected brand data and at least one attribute related to the selected category-and-subcategory data for the selected brand data that makes online shopping more effective and efficient with less stress. In particular, the layout of the customer curated storefront electronic interface generated in real time helps to streamline the decision-making process by consumers and increases resulting electronic online shopping purchases. The layout of the customer curated storefront electronic interface is also structured to optionally provide direct electronic communication between the vendor or manufacture of each product on the electronic interface to further enhance the customer service experience. Even further, with this technology vendor systems are in real time linked and are continuously provided with updated intelligence data saving vendors substantial time and money with respect to market research, managing inventory, and directing targeted advertising.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
establishing, by a computing device, one or more communication links with one or more vendor computing systems based on selected category-and-subcategory data for selected brand data in a customized shopping preference data set associated with a digital identifier, wherein the customized shopping preference data set is solely based on consumer input data associated with the digital identifier and comprises the selected category-and-subcategory data for the selected brand data, consumer characteristic data, and one or more types of notifications related to the selected category-and-subcategory data;
generating in real time, by the computing device, an arrangement of a layout of a customer curated storefront electronic interface based on a real time correlation of any of a plurality of items at the one or more linked vendor systems matching the consumer characteristic data, the selected category-and-subcategory data for the selected brand data, at least one attribute related to the selected categories and subcategories for the selected brand data, and stored interface layout structure data; and
providing, by the computing device, the real time generated layout of the customer curated storefront electronic interface to a consumer device associated with the digital identifier.

2. The method as set forth in claim 1 further comprising:
identifying, by the computing device, when one of the plurality of items at one of the vendor computing system satisfies one of the types of notifications based on the consumer characteristics data, the selected category-and-subcategory data, and the at least one other attribute; and
transmitting, by the computing device, a generated electronic announcement to the consumer device associated with the digital identifier based on the identified one of the plurality of items at one of the vendor computing system that satisfies one of the types of notifications.

3. The method as set forth in claim 1 wherein the one or more types of notifications further comprise:
a new release notification for a new one of the plurality of items that in one of the selected categories and subcategories for the selected brand data; and
a sale notification for one of the plurality of items that in one of the selected categories and subcategories for the selected brand data.

4. The method as set forth in claim 1 wherein the at least one attribute comprises seasonal data for at least one of one or more seasons, one or more holidays, or one or more events.

5. The method as set forth in claim 1 further comprising determining, by the computing device, an amount of at least one of the items at one of the vendor computing systems to manufacture based on at least the customized shopping preference data set.

6. The method as set forth in claim 1 further comprising:
identifying, by the computing device, when to target the consumer device associated with the digital identifier for electronic advertisement data for one of the items based on the customized shopping preference data set; and
providing, by the computing device, the electronic advertisement data in the layout of the customer curated storefront electronic interface.

7. An apparatus comprising:
a processor; and
a memory coupled to the processor which is configured to be capable of executing programmed instructions comprising and stored in the memory to:
establish one or more communication links with one or more vendor computing systems based on selected category-and-subcategory data for selected brand data in a customized shopping preference data set associated with a digital identifier, wherein the customized shopping preference data set is solely based on consumer input data associated with the digital identifier and comprises the selected category-and-subcategory data for the selected brand data, consumer characteristic data, and one or more types of notifications related to the selected category-and-subcategory data;
generate in real time an arrangement of a layout of a customer curated storefront electronic interface based on a real time correlation of any of a plurality of items at the one or more linked vendor systems matching the consumer characteristic data, the selected category-and-subcategory data for the selected brand data, at least one attribute related to the selected categories and subcategories for the selected brand data, and interface layout structure data; and
provide the real time generated layout of the customer curated storefront electronic interface to a consumer device associated with the digital identifier.

8. The apparatus as set forth in claim 7 wherein the processor is further configured for the generating to be capable of executing the stored programmed instructions to:
identify when one of the plurality of items at one of the vendor computing system satisfies one of the types of notifications based on the consumer characteristics data, the selected category-and-subcategory data, and the at least one other attribute; and
transmit a generated electronic announcement to the consumer device associated with the digital identifier based on the identified one of the plurality of items at one of the vendor computing system that satisfies one of the types of notifications.

9. The apparatus as set forth in claim 7 wherein the one or more types of notifications further comprise:
a new release notification for a new one of the plurality of items that in one of the selected categories and subcategories for selected brand data; and
a sale notification for one of the plurality of items that in one of the selected categories and subcategories for selected brand data.

10. The apparatus as set forth in claim 7 wherein the at least one attribute comprises seasonal data for at least one of one or more seasons, one or more holidays, or one or more events.

11. The apparatus as set forth in claim 7 wherein the processor is further configured for the generating to be capable of executing the stored programmed instructions to determine an amount of at least one of the items at one of the vendor computing systems to manufacture based on at least the customized shopping preference data set.

12. The apparatus as set forth in claim 7 wherein the processor is further configured for the generating to be capable of executing the stored programmed instructions to:
identify when to target the consumer device associated with the digital identifier for electronic advertisement data for one of the items based on the customized shopping preference data set; and
provide the electronic advertisement data in the layout of the customer curated storefront electronic interface.

13. A non-transitory computer readable medium having stored thereon instructions comprising executable code which when executed by one or more processors, causes the one or more processors to:
establish one or more communication links with one or more vendor computing systems based on selected category-and-subcategory data for selected brand data in a customized shopping preference data set associated with a digital identifier, wherein the customized shopping preference data set is solely based on consumer input data associated with the digital identifier and comprises the selected category-and-subcategory data for selected brand data, consumer characteristic data, and one or more types of notifications related to the selected category-and-subcategory data;
generate in real time an arrangement of a layout of a customer curated storefront electronic interface based on a real time correlation of any of a plurality of items at the one or more linked vendor systems matching the consumer characteristic data, the selected category-and-subcategory data for the selected brand data, at least one attribute related to the selected categories and subcategories for the selected brand data, and interface layout structure data; and
provide the real time generated layout of the customer curated storefront electronic interface to a consumer device associated with the digital identifier.

14. The medium as set forth in claim 13 wherein the executable code when executed by the one or more processors further causes the one or more processors to:
identify when one of the plurality of items at one of the vendor computing system satisfies one of the types of notifications based on the consumer characteristics data, the selected category-and-subcategory data, and the at least one other attribute; and
transmit a generated electronic announcement to the consumer device associated with the digital identifier based on the identified one of the plurality of items at one of the vendor computing system that satisfies one of the types of notifications.

15. The medium as set forth in claim 13 wherein the one or more types of notifications further comprise:
a new release notification for a new one of the plurality of items that in one of the selected categories and subcategories for selected brand data; and
a sale notification for one of the plurality of items that in one of the selected categories and subcategories for selected brand data.

16. The medium as set forth in claim 13 wherein the at least one attribute comprises seasonal data for at least one of one or more seasons, one or more holidays, or one or more events.

17. The medium as set forth in claim 13 wherein the executable code when executed by the one or more processors further causes the one or more processors to determine an amount of at least one of the items at one of the vendor computing systems to manufacture based on at least the customized shopping preference data set.

18. The medium as set forth in claim 13 wherein the executable code when executed by the one or more processors further causes the one or more processors to:
identify when to target the consumer device associated with the digital identifier for electronic advertisement data for one of the items based on the customized shopping preference data set; and
provide the electronic advertisement data in the layout of the customer curated storefront electronic interface.
